(19) United States
(12) Patent Application Publication
(10) Pub. No.: US 2017/0235460 A1
(43) Pub. Date: Aug. 17, 2017

(54) METHODS AND SYSTEMS FOR IMPLEMENTING AN ALWAYS-ON-TOP DATA-ACQUISITION BUTTON

(71) Applicant: SYMBOL TECHNOLOGIES, LLC, Lincolnshire, IL (US)

(72) Inventor: KE LI, EAST ISLIP, NY (US)

(21) Appl. No.: 15/041,547

(22) Filed: Feb. 11, 2016

(51) Int. Cl. G06F 3/0484; G06F 3/0482; G06F 3/0488

(52) U.S. Cl. CPC G06F 3/04842; G06F 3/0488; G06F 3/0482

(57) ABSTRACT

Disclosed herein are methods and systems for implementing an always-on-top data-acquisition button. One embodiment takes the form of a portable electronic device (PED) that includes a touchscreen display via which the PED is configured to present a plurality of different non-lock-screen views at different times, a set of one or more sensors, a processor, and a data storage. The data storage contains instructions executable by the processor for causing the PED to carry out functions that include displaying, via the touchscreen display, an always-on-top data-acquisition button that is visible on the touchscreen display regardless of which of the different non-lock-screen views is currently displayed; detecting, via the touchscreen display, an actuation of the always-on-top data-acquisition button, and responsively capturing data using a subset of the set of one or more sensors; and storing the captured data in the data storage.

### BACKGROUND OF THE INVENTION

The portable electronic device (PED) is one of the most effective modern tools and has a vast variety of applications in a plurality of different industries. Typically, a PED includes an electronic processor, data storage, and some means of interfacing with the external environment (e.g., with a user, with various wireless signals, with visual information, etc.). Many PEDs enable further data-capture functionality by including a set of sensors that translate various forms of information (e.g., various forms of electromagnetic information, acceleration information, etc.) into digital and/or analog signals that are then interpreted by the processor.

Modern PEDs often employ touchscreens that facilitate user input as well as visual feedback in a simple intuitive manner. A user can typically navigate a PED's operating system and all of the associated functionality via a graphical user interface (GUI) presented via the touchscreen. In fact, a PED's user-friendliness is directly related to the particular GUI that is implemented. Modern GUIs allow a user to control the various hardware elements included within the PED without requiring any knowledge of computer code, computer engineering, or the like. For example, a virtual button for activating a data-capture mechanism via a particular sensor (e.g., a camera, a microphone, a gyroscope, etc.) may be displayed within the GUI. This allows a user with no expertise with regard to how the sensor works to effectively interface with that hardware. Such users often view different types of screens and views on their PEDs. Accordingly, there is a need for methods and systems for implementing an always-on-top data-acquisition button.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts an example PED, in accordance with some embodiments.

FIG. 2A depicts a first view of the example PED of FIG. 1, in accordance with some embodiments.

FIG. 2B depicts a second view of the example PED of FIG. 1, in accordance with some embodiments.

FIG. 2C depicts a third example view of the example PED of FIG. 1, in accordance with some embodiments.

FIG. 3A depicts a fourth example view of the example PED of FIG. 1, in accordance with some embodiments.

FIG. 3B depicts a fifth example view of the example PED of FIG. 1, in accordance with some embodiments.

FIG. 3C depicts a sixth example view of the example PED of FIG. 1, in accordance with some embodiments.

FIG. 4 depicts a seventh example view of the example PED of FIG. 1, in accordance with some embodiments.

FIG. 5 depicts an architectural view of the example PED of FIG. 1, in accordance with some embodiments.

FIG. 6 depicts an example method, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

One embodiment takes the form of a computer-implemented method that is carried out at a PED. In such an embodiment, the PED includes a touchscreen display via which the PED is configured to present a plurality of different non-lock-screen views at different times, a set of one or more sensors, and a data storage. The method includes displaying, via the touchscreen display, an always-on-top data-acquisition button that is visible on the touchscreen display regardless of which of the different non-lock-screen views is currently displayed. The method also includes detecting, via the touchscreen display, an actuation of the always-on-top data-acquisition button, and responsively capturing data using a subset of the set of one or more sensors. The method also includes storing the captured data in the data storage.

Another embodiment takes the form of a PED that includes a touchscreen display via which the PED is configured to present a plurality of different non-lock-screen views at different times. The PED includes a set of one or more sensors. The PED also includes a processor and data storage containing instructions executable by the processor for causing the PED to carry out a set of functions. The set of functions includes displaying, via the touchscreen display, an always-on-top data-acquisition button that is visible on the touchscreen display regardless of which of the different non-lock-screen views is currently displayed. The set of functions includes detecting, via the touchscreen display, an actuation of the always-on-top data-acquisition button, and responsively capturing data using a subset of the set of one or more sensors. The set of functions also includes storing the captured data in the data storage.

In at least one embodiment, the plurality of different non-lock-screen views includes a home-screen view.

In at least one embodiment, the plurality of different non-lock-screen views includes a foreground-application view.

In at least one embodiment, the plurality of different non-lock-screen views includes a foreground-document view.

In at least one embodiment, the set of sensors includes one or more of a laser scanner, an imager, a camera, a microphone, an NFC reader, a proximity sensor, a Wi-Fi receiver, a Li-Fi receiver, a Bluetooth receiver, a radio-frequency identification (RFID) reader, a GPS module, a GLONASS module, a Galileo Positioning System module, an Indian Regional Navigation Satellite System module, a BeiDou Navigation Satellite System module, a Quasi-Zenith Satellite System module, an accelerometer, a gravity sensor, a gyroscope, a rotational vector sensor, a barometer, a photometer, a thermometer, a humidity sensor, an orientation sensor, a magnetometer, an electrode sensor, and a piezoelectric sensor.

In at least one embodiment, the subset consists of one sensor.

In at least one embodiment, the subset includes multiple sensors.

In at least one embodiment, the subset includes all of the sensors in the set.

In at least one embodiment, the subset is determined at least in part by a current non-lock-screen view.

In at least one embodiment, the subset is determined at least in part by a current location of the PED.

In at least one embodiment, the subset is determined at least in part by a current data-acquisition mode of the PED. In at least one such embodiment, the data-acquisition mode is user-configurable.

In at least one embodiment, the always-on-top data-acquisition button is implemented as part of an operating system of the PED.

In at least one embodiment, the always-on-top data-acquisition button is implemented as a service that is executed by an operating system of the PED.

In at least one embodiment, the always-on-top data-acquisition button is implemented as an application that is executed by an operating system of the PED.

In at least one embodiment, the always-on-top data-acquisition button is a first always-on-top data-acquisition button, the subset is a first subset, and the captured data is first captured data, the method further includes (i) displaying, via the touchscreen display, a second always-on-top data-acquisition button that is also visible on the touchscreen display regardless of which of the different non-lock-screen views is currently displayed, (ii) detecting, via the touchscreen display, an actuation of the second always-on-top data-acquisition button, and responsively capturing second data using a second subset of the set of one or more sensors, wherein the first subset is not equal to the second subset; and (iii) storing the captured second data in the memory of the PED. In at least one such embodiment, at least one of the first and second subsets is not user-configurable.

In at least one embodiment, the method further includes displaying, via the touchscreen display, a lock-screen view with the always-on-top data-acquisition button visible.

In at least one embodiment, an operating system of the PED is Android, an Android derivative, Windows Phone, iOS, Windows, BlackBerry 10, Firefox OS, Sailfish OS, Tizen, or Ubuntu Touch OS.

Moreover, any of the variations and permutations described herein can be implemented with respect to any embodiments, including with respect to any method embodiments and with respect to any system embodiments. Furthermore, this flexibility and cross-applicability of embodiments is present in spite of the use of slightly different language (e.g., process, method, steps, functions, set of functions, and the like) to describe and or characterize such embodiments.

Before proceeding with this detailed description, it is noted that the entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—can only properly be read as being constructively preceded by a clause such as “In at least one embodiment, . . . ” And it is for reasons akin to brevity and clarity of presentation that this implied leading clause is not repeated ad nauseum in this detailed description.

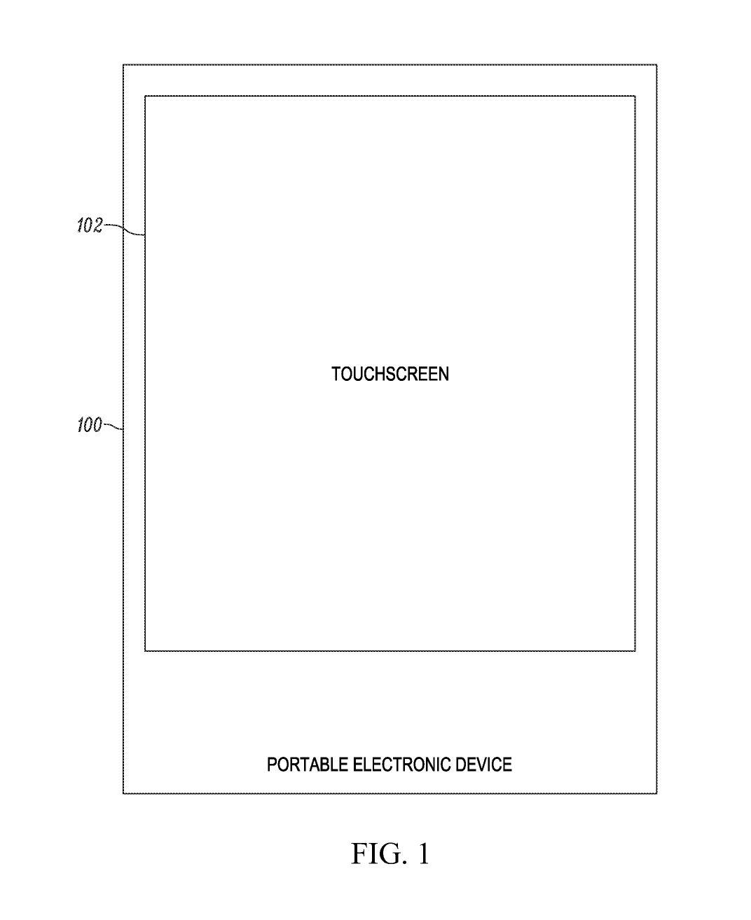

FIG. 1 depicts an example PED, in accordance with some embodiments. In particular, FIG. 1 depicts a PED 100 that could be any of a number of different types (i.e., a smartphone, a tablet, a personal computer, or an electronic reader). Moreover, the PED 100 may be configured with any number of different operating systems (e.g., Android or iOS).

Returning to FIG. 1, the PED 100 includes a touchscreen 102, which enables the user to interact with what is displayed on the PED 100. A user can interact with the touchscreen 102 in any of a number of different ways (e.g., stylus, pen, special coated gloves, or one or more fingers). The touchscreen 102 could present any of a number of different views, including lock-screen views and non-lock-screen views. Among the options for non-lock-screen views are home-screen views, foreground-application views, and foreground-document views. It is noted that foreground-application views could be single-application views or multiple-application views. Similarly, foreground-document views could be single-document views or multiple-document views. And combination views of these options could be implemented as well.

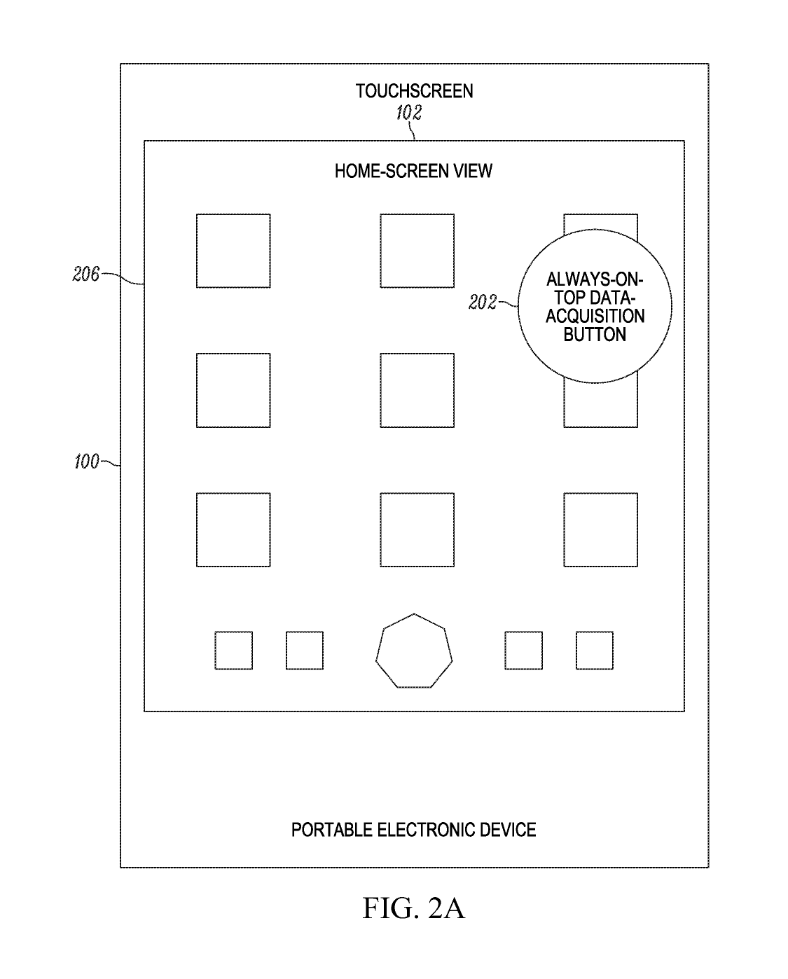

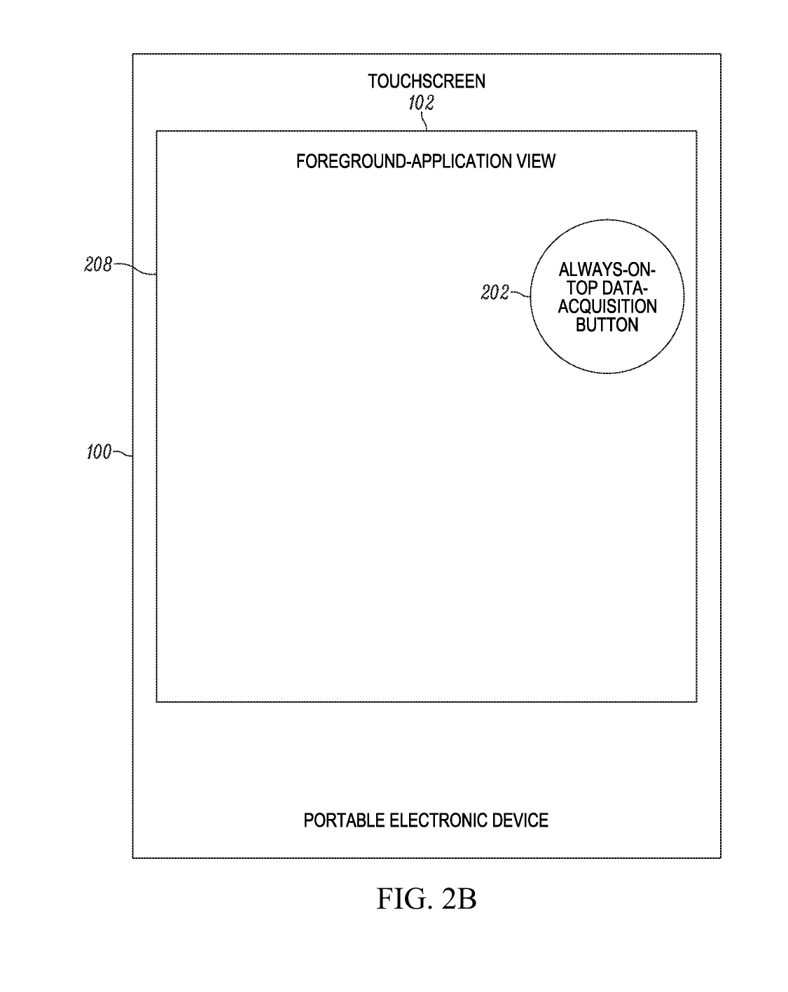

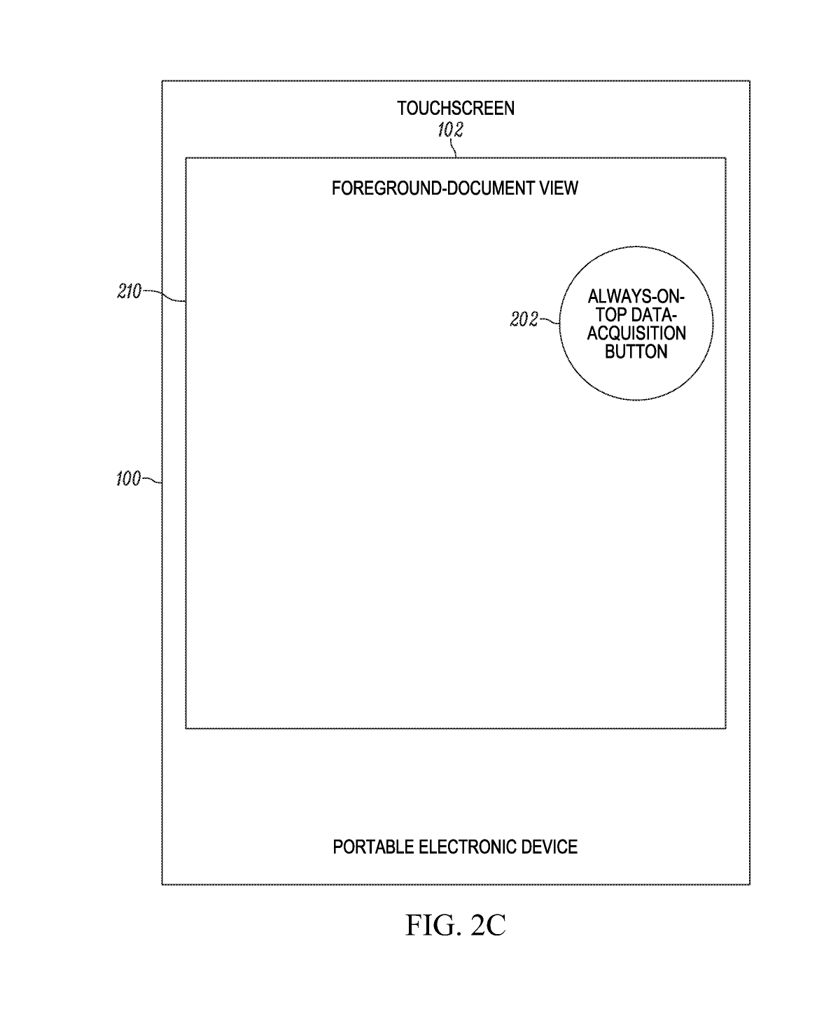

FIGS. 2A-2C depict several non-lock-screen views of the example PED of FIG. 1, in accordance with some embodiments.

FIG. 2A depicts the PED 100, the touchscreen 102, an always-on-top data-acquisition button 202, and a home-screen view 206. The touchscreen 102 may present a plurality of different non-lock-screen views. In one embodiment, as disclosed in FIG. 2A, the touchscreen 102 displays a home-screen view 206. The home-screen view 206 may display a number of different applications (e.g., icons associated with applications) which may be accessed on the PED 100. The home-screen view 206 may also display a number of different documents (e.g., shortcuts or other types of icons associated with documents) that may be accessed on the PED 100. And the home-screen view 206 may contain other displayed elements as well.

In at least one embodiment, as disclosed in FIG. 2B, the touchscreen 102 displays a foreground-application view 208. In one embodiment, the foreground-application view 208 relates to an application accessed from the home-screen view 206. The foreground-application view 208 could be any of a number of different applications (e.g., a web browser, a data-acquisition application, an electronic-reader application, etc.). And certainly other example applications could be listed here as well.

In at least one embodiment, as disclosed in FIG. 2C, the touchscreen 102 displays a foreground-document view 210. In one embodiment, the foreground-document view 210 is a document accessed from the home-screen view 206, perhaps viewed with the aid of an application, perhaps viewed with a service provided by an operating system (e.g., a PDF viewer), or perhaps some other option. The foreground-document view 210 could be a number of different documents (e.g., a publication). And certainly other example documents could be listed here as well.

Returning to FIG. 2A, the always-on-top data-acquisition button 202 is presented. In an embodiment, the always-on-top data-acquisition button 202 is an operating-system-level soft button that causes a data-capture function (e.g., barcode scanning) to be triggered anywhere within the operating system. The always-on-top data-acquisition button 202 may be implemented in multiple different ways. In one embodiment, the always-on-top data-acquisition button 202 is implemented as part of the operating system of the PED 100. In another embodiment, the always-on-top data-acquisition button 202 is implemented as a service that is executed by the operating system of the PED 100. In another embodiment, the always-on-top data-acquisition button 202 is implemented as an application that is executed by the operating system of the PED 100. And certainly other example implementations could be listed here as well.

Moreover, the always-on-top data-acquisition button 202 is displayed on the PED 100 such that it is always “on top” of the non-lock-screen view presented on the touchscreen display 102. For example, in one embodiment, the always-on-top data-acquisition button 202 is displayed on top of the home-screen view 206. In another embodiment, the always-on-top data-acquisition button 202 is displayed on top of the foreground-application view 208. In another embodiment, the always-on-top data-acquisition button 202 is displayed on top of the foreground-document view 210. And certainly other example implementations could be listed here as well.

The always-on-top data-acquisition button 202 may be configured to trigger acquisition of data using a subset of the sensors with which the PED 100 is equipped and/or operably connected (e.g., by a USB and/or Bluetooth connection). In various different embodiments, the PED 100 is equipped with one or more of a laser scanner, an imager, a camera, a microphone, an NFC reader, a proximity sensor, a Wi-Fi receiver, a Li-Fi receiver, a Bluetooth receiver, an RFID reader, a GPS module, a GLONASS module, a Galileo Positioning System module, an Indian Regional Navigation Satellite System module, a BeiDou Navigation Satellite System module, a Quasi-Zenith Satellite System module, an accelerometer, a gravity sensor, a gyroscope, a rotational vector sensor, a barometer, a photometer, a thermometer, a humidity sensor, an orientation sensor, a magnetometer, an electrode sensor, and a piezoelectric sensor. And certainly other example sensors could be listed.

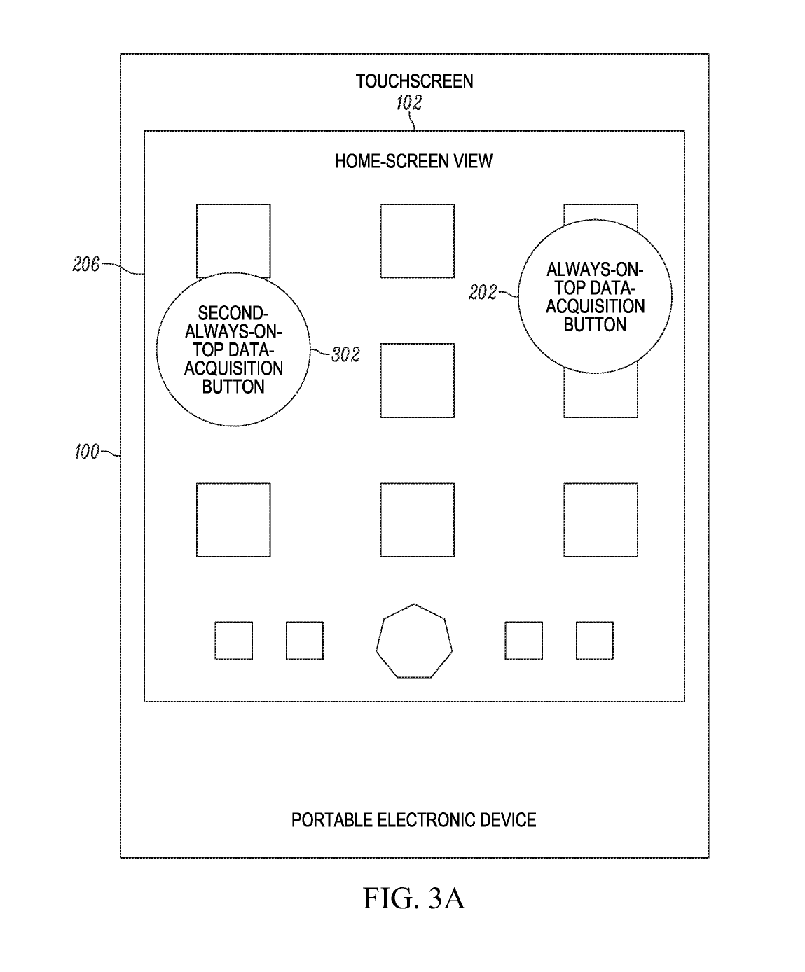

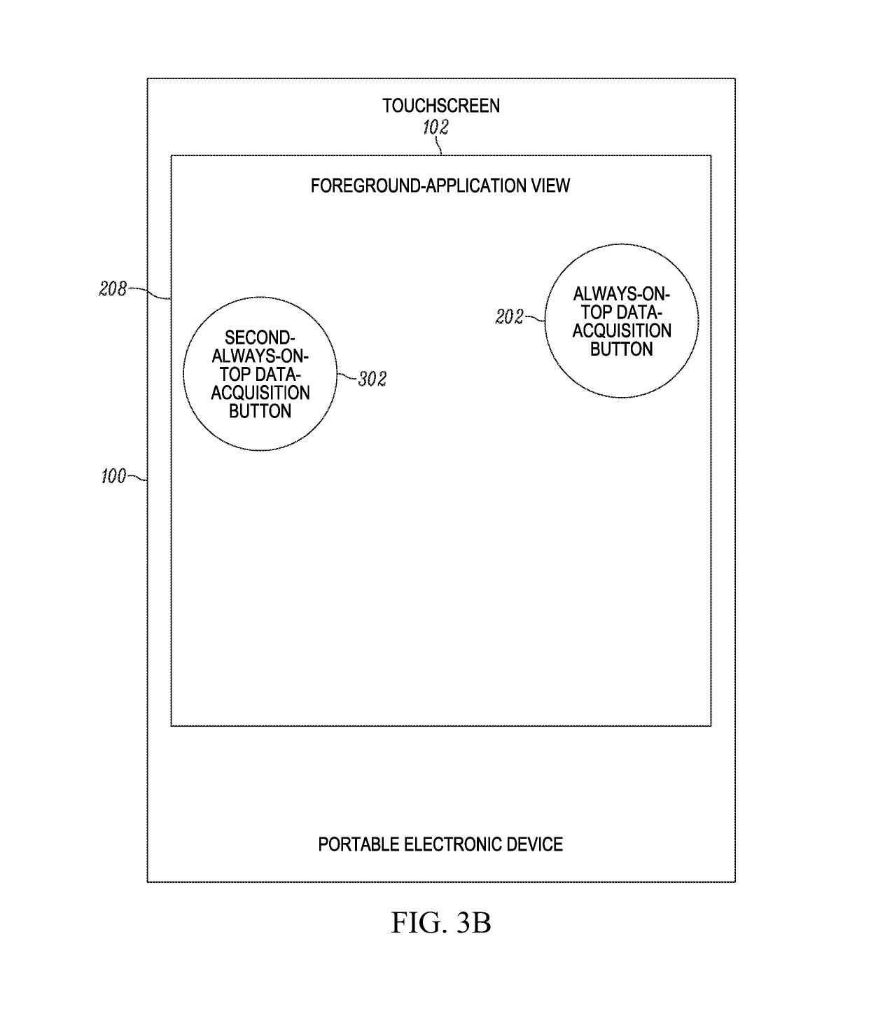

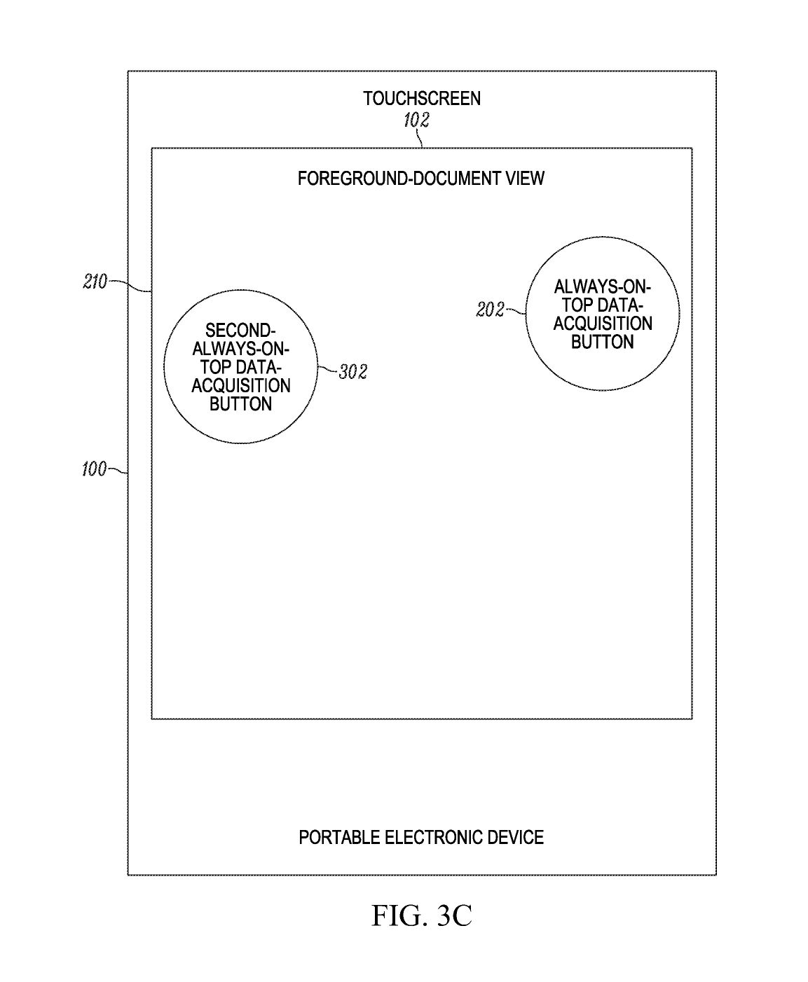

FIGS. 3A-3C depict several additional views of the example PED of FIG. 1, in accordance with some embodiments. In particular, FIG. 3A, depicts the PED 100, the touchscreen 102, the always-on-top data-acquisition button 202, a second-always-on-top data-acquisition button 302, and the home-screen view 206. As discussed above, the touchscreen 102 may present a plurality of different non-lock-screen views.

In one embodiment, as disclosed in FIG. 3A, the touchscreen 102 displays two always-on-top data-acquisition buttons 202 and 302 overlaid on the home-screen view 206, in another embodiment, as disclosed in FIG. 3B, the touchscreen 102 displays two always-on-top data-acquisition buttons 202 and 302 overlaid on the foreground-application view 208, and in another embodiment as disclosed in FIG. 3C, the touchscreen 102 displays two always-on-top data-acquisition buttons 202 and 302 overlaid on the foreground-document view 210. The second always-on-top data-acquisition button 302 may be configured to acquire data by using a subset of the sensors with which the PED 100 is equipped and/or operably connected (e.g., by a USB and/or Bluetooth connection). And certainly other example implementations could be listed here as well. Moreover, while two always-on-top data-acquisition buttons 202 and 302 are depicted in each of FIGS. 3A-3C, any multiple number of always-on-top data-acquisition buttons could be presented in various different implementations.

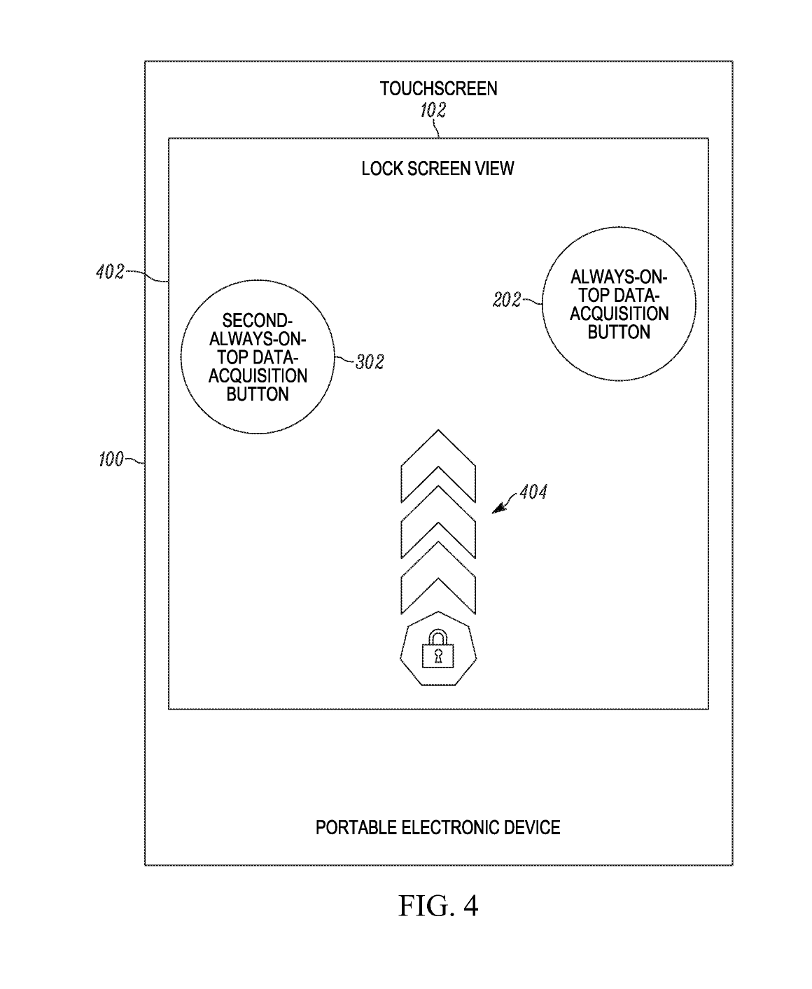

FIG. 4 depicts another example view of the example PED of FIG. 1, in accordance with some embodiments. In particular, FIG. 4 depicts the PED 100, the touchscreen 102, the always-on-top data-acquisition button 202, the second always-on-top data-acquisition button 302, and a lock-screen view 402 that includes an unlock icon 404. In one embodiment, the lock-screen view 402 is a locked-mode feature of the PED 100. The lock-screen view 402 may be triggered in any number of different ways (e.g., voice triggering, touch triggering, and a default time trigger). And certainly other examples can be listed here as well. Thus, FIG. 4 is an example of an embodiment in which the PED 100 displays one or more always-on-top data-acquisition buttons overlaid on a lock-screen view, in this case the lock-screen view 402.

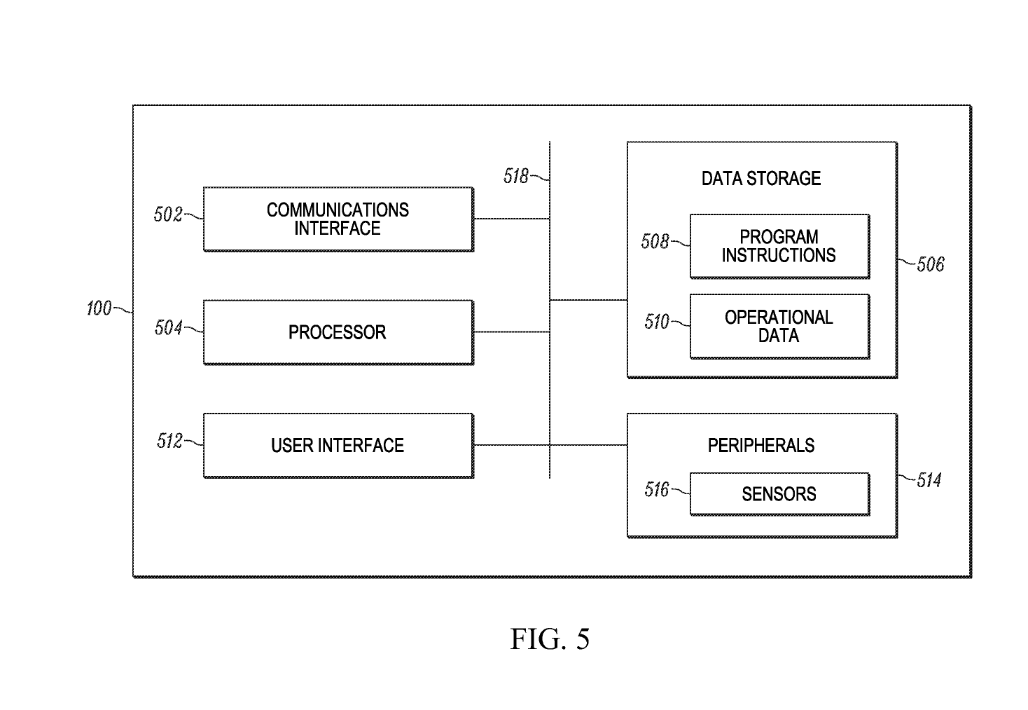

FIG. 5 depicts an architectural view of the example PED of FIG. 1, in accordance with some embodiments. The example PED 100 may be configured to carry out the functions described herein, and as depicted includes a communications interface 502, a processor 504, data storage 506 (that contains program instructions 508 and operational data 510), a user interface 512, peripherals 514 (that include sensors 516), and a communication bus 518. This arrangement is presented by way of example and not limitation, as other example arrangements could be described here.

The communication interface 502 may be configured to be operable for communication according to one or more wireless-communication protocols, some examples of which include LMR, LTE, APCO P25, ETSI DMR, TETRA, Wi-Fi, Bluetooth, and the like. The communication interface 502 may also or instead include one or more wired-communication interfaces (for communication according to, e.g., Ethernet, USB, and/or one or more other protocols.) The communication interface 502 may include any necessary hardware (e.g., chipsets, antennas, Ethernet interfaces, etc.), any necessary firmware, and any necessary software for conducting one or more forms of communication with one or more other entities as described herein.

The processor 504 may include one or more processors of any type deemed suitable by those of skill in the relevant art, some examples including a general-purpose microprocessor and a dedicated digital signal processor (DSP).

The data storage 506 may take the form of any non-transitory computer-readable medium or combination of such media, some examples including flash memory, read-only memory (ROM), and random-access memory (RAM) to name but a few, as any one or more types of non-transitory data-storage technology deemed suitable by those of skill in the relevant art could be used. As depicted in FIG. 5, the data storage 506 contains program instructions 508 executable by the processor 504 for carrying out various functions described herein, and further is depicted as containing operational data 510, which may include any one or more data values stored by and/or accessed by the computing device in carrying out one or more of the functions described herein.

The user interface 512 may include one or more input devices (a.k.a. components and the like) and/or one or more output devices (a.k.a. components and the like.) With respect to input devices, the user interface 512 may include one or more touchscreens (such as the touchscreen 102), buttons, switches, microphones, and the like. With respect to output devices, the user interface 512 may include one or more displays, speakers, light emitting diodes (LEDs), and the like. Moreover, one or more components (e.g., an interactive touchscreen and display such as the touchscreen 102) of the user interface 512 could provide both user-input and user-output functionality. Other user interface components could also be present, as known to those of skill in the art.

The peripherals 514 may include any computing device accessory, component, or the like, that is accessible to and useable by the PED 100 during operation. In some embodiments, the peripherals 514 includes a set of sensors 516. In some embodiments, the set of sensors 516 includes one or more of a laser scanner, an imager, a camera, a microphone, an NFC reader, a proximity sensor, a Wi-Fi receiver, a Li-Fi receiver, a Bluetooth receiver, a radio-frequency identification (RFID) reader, a GPS module, a GLONASS module, a Galileo Positioning System module, an Indian Regional Navigation Satellite System module, a BeiDou Navigation Satellite System module, a Quasi-Zenith Satellite System module, an accelerometer, a gravity sensor, a gyroscope, a rotational vector sensor, a barometer, a photometer, a thermometer, a humidity sensor, an orientation sensor, a magnetometer, an electrode sensor, and a piezoelectric sensor. And certainly other example peripherals could be listed.

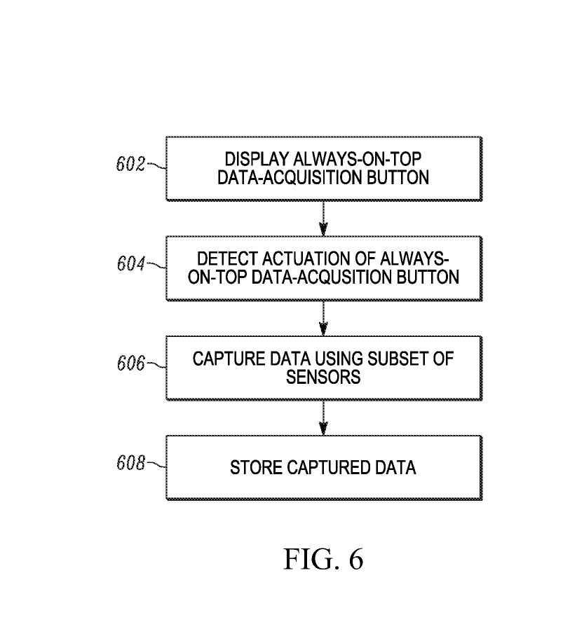

FIG. 6 depicts an example method, in accordance with some embodiments. In particular, FIG. 6 depicts a method 600 that includes steps 602, 604, 606, and 608, and is described below by way of example as being carried out by the PED 100, though in general the method 600 could be carried out by any PED that is suitably equipped, programmed, and configured.

In step 602, the PED 100 displays the always-on-top data-acquisition button 202 such that the always-on-top data-acquisition button 202 is visible on the touchscreen 102 regardless of which of the different non-lock-screen views (e.g., the home-screen view 206, the foreground-application view 208, or the foreground-document view 210) is currently displayed on the touchscreen 102. As described above, the always-on-top data-acquisition button 202 is displayed on the PED 100 such that it is always “on top” of at least whatever non-lock-screen view is being depicted via the touchscreen 102. The PED 100 may also display a second always-on-top data-acquisition button 302 on the touchscreen display 102.

In step 604, the PED 100 detects actuation of one or more always-on-top data-acquisition buttons. This step may be performed in several different ways. In one embodiment, the PED 100 detects actuation by manual triggering of the always-on-top data-acquisition button 202. The always-on-top data-acquisition button 202 may be manually triggered and responsively transmit a corresponding signal to a processor, controller, or the like of the PED 100. Similarly, the second always-on-top data-acquisition 302 may be manually triggered and responsively transmit a corresponding signal to a processor, controller, or the like of the PED 100. And certainly other example implementations are possible.

In step 606, responsive to detecting actuation of one or more always-on-top data-acquisition buttons at step 604, the PED 100 captures data using a subset of the set of one or more sensors 516. This step may be performed in several different ways. In one embodiment, upon actuation of the always-on-top data-acquisition button 202, the PED 100 captures data using a subset of the set of one or more sensors 516.

In another embodiment, the always-on-top data-acquisition button 202 is a first always-on-top data-acquisition button, the subset is a first subset and the captured data is the first captured data. The PED 100 captures a first data using a first subset of the set of one or more sensors 516. The first data and first subset of the set of one or more sensors configurable to the always-on-top data-acquisition button 202. In another embodiment, the always-on-top data-acquisition button 302 is a second always-on-top data-acquisition button, the subset is a second subset and the captured data is the second captured data. The PED 100 captures a second data using a second subset of the set of one or more sensors 516. The second data and second subset of the set of one or more sensors 516 configurable to the second always-on-top data-acquisition button 302. And certainly other example implementations are possible.

The PED 100 may also be configured to select a subset of the set of one or more sensors 516 based on one or more always-on-top data-acquisition buttons. In one embodiment, the PED 100 is configured to select the first subset of the set of one or more sensors 516 based on the always-on-top data-acquisition button 202 and the second subset of the set of one or more sensors 516 based on the second always-on-top data-acquisition button 302. In such embodiments, the first subset of the set of one or more sensors 516 is not equal to the second subset of the set of one or more sensors 516. Further, in at least one embodiment, at least one of the first and second subsets of one or more sensors 516 is not user-configurable. And certainly other example implementations are possible.

In one embodiment, the subset includes only one sensor 516. In another embodiment, the subset includes multiple sensors 516. In another embodiment, the subset includes all of the sensors 516.

Further, the PED 100 may be configured to select the subset of the set of one or more sensors 516 based on the current view on the touchscreen 102 display. In one embodiment, the subset of the set of one or more sensors 516 with which data is captured at step 606 may be different when the PED 100 is displaying the home-screen view 206, the foreground-application view 208, and the foreground-document view 210. In some embodiments, different applications being in the foreground result in different subsets of sensors 516 being triggered in step 606. The subset of the set of one or more sensors 516 may also be selected based on the lock-screen view 402. And certainly other example implementations are possible.

The PED 100 may also be configured to select the subset of the sensors 516 that is triggered at step 606 based on the current location of the PED 100. The PED 100 may select a subset of the set of one or more sensors 516 based on the current location obtained by one or more of the peripherals 514. In one embodiment, the PED 100 selects the subset of sensors 516 based on a location obtained via a GPS module. In another embodiment, the PED 100 selects the subset of sensors 516 based on a proximity sensor. And certainly other example implementations are possible.

The PED 100 may also be configured to select the subset of the sensors 516 that gets triggered at step 606 based on a current data-acquisition mode of the PED 100. In one embodiment, the PED 100 selects a laser scanner based on being in a laser-scanner mode. In other embodiments, the PED 100 may select an imager when in an imager mode, or a camera when in a camera mode, and so on. In at least one embodiment, the current data-acquisition mode is user-configurable. In another embodiment, the data-acquisition mode is not user-configurable. And certainly other example implementations are possible.

In step 608, the PED 100 stores in data storage the data captured at step 606 by the subset of sensors 516. This step may be performed in several different ways. In one embodiment, upon actuation of the always-on-top data-acquisition button 202, the PED 100 stores first data in ROM data storage 506. In another embodiment, upon actuation of the second always-on-top data-acquisition button 302, the PED 100 stores second data in RAM data storage 506. And certainly other example implementations are possible.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-implemented method comprising:
at a portable electronic device (PED) comprising:
a touchscreen display via which the PED is configured to present a plurality of different non-lock-screen views at different times,
a set of one or more sensors, and
a data storage,
displaying, via the touchscreen display, an always-on-top data-acquisition button that is visible on the touchscreen display regardless of which of the different non-lock-screen views is currently displayed;
detecting, via the touchscreen display, an actuation of the always-on-top data-acquisition button, and responsively capturing data using a subset of the set of one or more sensors; and
storing the captured data in the data storage.

2. The method of claim 1, wherein the plurality of different non-lock-screen views includes a home-screen view.

3. The method of claim 1, wherein the plurality of different non-lock-screen views includes a foreground-application view.

4. The method of claim 1, wherein the plurality of different non-lock-screen views includes a foreground-document view.

5. The method of claim 1, wherein the set of sensors includes one or more of a laser scanner, an imager, a camera, a microphone, an NFC reader, a proximity sensor, a Wi-Fi receiver, a Li-Fi receiver, a Bluetooth receiver, a radio-frequency identification (RFID) reader, a GPS module, a GLONASS module, a Galileo Positioning System module, an Indian Regional Navigation Satellite System module, a BeiDou Navigation Satellite System module, a Quasi-Zenith Satellite System module, an accelerometer, a gravity sensor, a gyroscope, a rotational vector sensor, a barometer, a photometer, a thermometer, a humidity sensor, an orientation sensor, a magnetometer, an electrode sensor, and a piezoelectric sensor.

6. The method of claim 1, wherein the subset consists of one sensor.

7. The method of claim 1, wherein the subset includes multiple sensors.

8. The method of claim 1, wherein the subset includes all of the sensors in the set.

9. The method of claim 1, wherein the subset is determined at least in part by a current non-lock-screen view.

10. The method of claim 1, wherein the subset is determined at least in part by a current location of the PED.

11. The method of claim 1, wherein the subset is determined at least in part by a current data-acquisition mode of the PED.

12. The method of claim 11, wherein the data-acquisition mode is user-configurable.

13. The method of claim 1, wherein the always-on-top data-acquisition button is implemented as part of an operating system of the PED.

14. The method of claim 1, wherein the always-on-top data-acquisition button is implemented as a service that is executed by an operating system of the PED.

15. The method of claim 1, wherein the always-on-top data-acquisition button is implemented as an application that is executed by an operating system of the PED.

16. The method of claim 1, wherein the always-on-top data-acquisition button is a first always-on-top data-acquisition button, the subset is a first subset, and the captured data is first captured data, the method further comprising:
displaying, via the touchscreen display, a second always-on-top data-acquisition button that is also visible on the touchscreen display regardless of which of the different non-lock-screen views is currently displayed;
detecting, via the touchscreen display, an actuation of the second always-on-top data-acquisition button, and responsively capturing second data using a second subset of the set of one or more sensors, wherein the first subset is not equal to the second subset; and
storing the captured second data in the memory of the PED.

17. The method of claim 16, wherein at least one of the first and second subsets is not user-configurable.

18. The method of claim 1, further comprising displaying, via the touchscreen display, a lock-screen view with the always-on-top data-acquisition button visible.

19. The method of claim 1, wherein an operating system of the PED is Android, iOS or Windows.

20. A portable electronic device (PED) comprising:
a touchscreen display via which the PED is configured to present a plurality of different non-lock-screen views at different times;
a set of one or more sensors;
a processor; and
data storage containing instructions executable by the processor for causing the PED to carry of a set of functions, the set of functions including:
displaying, via the touchscreen display, an always-on-top data-acquisition button that is visible on the touchscreen display regardless of which of the different non-lock-screen views is currently displayed;
detecting, via the touchscreen display, an actuation of the always-on-top data-acquisition button, and responsively capturing data using a subset of the set of one or more sensors; and
storing the captured data in the data storage.
